(19) United States
(12) Patent Application Publication
(10) Pub. No.: US 2024/0151289 A1
(43) Pub. Date: May 9, 2024

(54) MULTI-TUBE VIBRATION DAMPER HAVING ADJUSTABLE DAMPING FORCE FOR A VEHICLE

(71) Applicants: thyssenkrupp Bilstein GmbH, Ennepetal (DE); thyssenkrupp AG, Essen (DE)

(72) Inventor: Freddy WOENARTA, Braunschweig (DE)

(73) Assignees: thyssenkrupp Bilstein GmbH, Ennepetal (DE); thyssenkrupp AG, Essen (DE)

(21) Appl. No.: 18/281,744

(22) PCT Filed: Mar. 4, 2022
(86) PCT No.: PCT/EP2022/055516

§ 371 Date: Sep. 12, 2023

(30) Foreign Application Priority Data
Mar. 12, 2021 (DE) 10 2021 202 418.1

(51) Int. Cl. F16F 9/32

(52) U.S. Cl. CPC F16F 9/3257; F16F 9/325

(57) ABSTRACT

A multi-tube vibration damper having adjustable damping force for a vehicle, including a damper inner tube that is filled at least partially with damping medium and has a damper inner tube wall, a damper outer tube having a damper outer tube wall, wherein the damper outer tube is arranged coaxially around the damper inner tube, and a compensation chamber is formed between the damper outer tube and the damper inner tube; a damping module having a connecting piece, wherein the damping module is arranged on the outside of the damper outer tube wall, and the connecting piece runs fluid-tightly from the damping module through a damper tube outer wall opening for fluid connection between the working chamber remote from the piston rod and the damping module and opens fluid-tightly into a damper tube inner wall opening.

The present invention relates to a multi-tube vibration damper having adjustable damping force for a vehicle.

### PRIOR ART

Multi-tube vibration dampers having adjustable damping force for vehicles are known in a large number of embodiments in the prior art.

The embodiments known in the prior art are problematic in that they comprise a complex structure and a large number of individual components.

The present invention is therefore based on the object of providing an improved multi-tube vibration damper with which the aforementioned disadvantages are avoided. In particular, this improved multi-tube vibration damper is intended to permit a simple structure and a reduction in the number of individual components.

### DISCLOSURE OF THE INVENTION

This object is achieved with a multi-tube vibration damper, in particular twin-tube vibration damper, having adjustable damping force for a vehicle according to claim 1.

The subject matter of the invention is a multi-tube vibration damper, in particular twin-tube vibration damper, having adjustable damping force for a vehicle, comprising
a damper inner tube that is filled at least partially with damping medium and has a damper inner tube wall, wherein the damper inner tube wall has a damper inner tube inner face and a damper inner tube outer face, wherein a piston rod is arranged movably back and forth in the damper inner tube, wherein a working piston is movable together with the piston rod, by means of which working piston the interior of the damper inner tube is divided into a working chamber on the piston rod side and a working chamber remote from the piston rod; a damper outer tube having a damper outer tube wall, wherein the damper outer tube is arranged coaxially around the damper inner tube, and a compensation chamber is formed between the damper outer tube and the damper inner tube; a damping module having a connecting piece, wherein the damping module is arranged on the outside of the damper outer tube wall, and the connecting piece runs fluid-tightly from the damping module through a damper outer tube wall opening for fluid connection between the working chamber remote from the piston rod and the damping module and opens fluid-tightly into a damper inner tube wall opening, wherein
a conduit is formed integrally from the damper inner tube wall, wherein the conduit protrudes into the interior of the damper inner tube and opens into the interior of the damper inner tube in the damper inner tube wall opening, wherein the connecting piece is arranged coaxially inside the conduit.

The multi-tube vibration damper according to the invention, in particular twin-tube vibration damper, having adjustable damping force for a vehicle has the advantage of a simpler structure, in particular having fewer part components, in comparison with conventional multi-tube vibration dampers. Furthermore, a larger volume is provided in the compensation chamber with the design according to the invention.

### DETAILED DESCRIPTION OF THE INVENTION

In the context of the present invention, the fact that the conduit is formed integrally from, in particular with, the damper tube means that the conduit is made of the damper inner tube wall, in particular of damper inner tube material, for example, deep drawn out of the damper inner tube wall. The conduit is in particular cylindrical, for example with an at least partially conical-cylindrical profile.

In a further embodiment of the invention, the damper inner tube wall opening is cylindrical, in particular has an edge that runs round cylindrically.

According to a further embodiment of the invention, a geometric transition structure is formed in the region between the damper inner tube wall, in particular the damper inner tube outer face, and the conduit, in particular the damper inner tube wall opening, said transition structure having a profile differing from an angular profile.

For example, the geometric transition structure is arranged coaxially with the connecting piece.

According to a further embodiment of the invention, the geometric transition structure is selected from a group of an indentation into the interior of the damper inner tube, a bulge into the compensation chamber, a spherical cap shape, a corrugated shape, or a combination thereof.

In the context of the present invention, an indentation means, for example, an impression, in particular a wholly or partially cup-shaped, tulip-shaped, bowl-shaped, plate-shaped, funnel-shaped, in particular a curve-shaped, rounded profile, in particular a wholly or partially concave region in the working chamber remote from the piston rod, or a combination thereof.

In a further embodiment of the invention, the geometric transition structure has a stepped profile, in particular one or more plateau-like regions, for example regions that run substantially coaxially with, in particular parallel to the damper outer tube wall.

According to a further embodiment of the invention, the connecting piece opening into the damper inner tube wall opening is sealed against the damper inner tube outer face by means of a sealing ring in the mouth region, in particular in the cylindrical region of the damper inner tube wall opening.

Specifically, the invention comprises the following first embodiments:
1. A first embodiment of the invention is a multi-tube vibration damper having adjustable damping force for a vehicle, comprising
   a damper inner tube that is filled at least partially with damping medium and has a damper inner tube wall, wherein a piston rod is arranged movably back and forth in the damper inner tube, wherein a working piston is movable together with the piston rod, by means of which working piston the interior of the damper inner tube is divided into a working chamber on the piston rod side and a working chamber remote from the piston rod; a damper outer tube having a damper outer tube wall, wherein the damper outer tube is arranged coaxially around the damper inner tube, and a compensation chamber is formed between the damper outer tube and the damper inner tube; a damping module having a connecting piece, wherein the damping module is arranged on the outside of the damper outer tube wall, and the connecting piece runs fluid-tightly from the damping module through a damper tube outer wall opening for fluid connection between the working chamber remote from the piston rod and the damping module and opens fluid-tightly into a damper tube inner wall opening, wherein
   a conduit is formed from the damper inner tube wall into the interior of the damper inner tube as far as the damper tube inner wall opening, wherein the conduit is formed integrally from the damper inner tube, wherein the connecting piece is arranged coaxially inside the conduit.
2. The multi-tube vibration damper according to the preceding embodiment 1, wherein the damper tube inner wall opening is cylindrical, in particular has an edge that runs round cylindrically.
3. The multi-tube vibration damper according to one of embodiments 1 to 2, wherein a geometric transition structure is formed in the region between the damper inner tube wall and the conduit, said transition structure having a profile differing from an angular profile.
4. The multi-tube vibration damper according to embodiment 3, wherein the geometric transition structure is selected from a group of an indentation into the interior of the damper inner tube, a bulge into the compensation chamber, a spherical cap shape, a corrugated shape, or a combination thereof.
5. The multi-tube vibration damper according to one of embodiments 3 to 4, wherein the geometric transition structure has a stepped profile.
6. The multi-tube vibration damper according to one of the preceding embodiments 1 to 5, wherein the connecting piece opening into the damper tube inner wall opening is sealed against the damper inner tube wall by means of a sealing ring in the mouth region, in particular in the cylindrical region of the damper tube inner wall opening.

Specifically, the invention comprises the following second embodiments:
1. A second embodiment of the invention is a multi-tube vibration damper having adjustable damping force for a vehicle, comprising
   a damper inner tube that is filled at least partially with damping medium and has a damper inner tube wall, wherein a piston rod is arranged movably back and forth in the damper inner tube, wherein a working piston is movable together with the piston rod, by means of which working piston the interior of the damper inner tube is divided into a working chamber on the piston rod side and a working chamber remote from the piston rod; a damper outer tube having a damper outer tube wall, wherein the damper outer tube is arranged coaxially around the damper inner tube, and a compensation chamber is formed between the damper outer tube and the damper inner tube; a damping module having a connecting piece, wherein the damping module is arranged on the outside of the damper outer tube wall, and the connecting piece runs fluid-tightly from the damping module through a damper outer tube wall opening for fluid connection between the working chamber remote from the piston rod and the damping module and opens fluid-tightly into a damper inner tube wall opening, wherein
   a conduit is formed integrally from the damper inner tube wall, wherein the conduit protrudes into the interior of the damper inner tube and opens into the interior of the damper inner tube in the damper inner tube wall opening, wherein the connecting piece is arranged coaxially inside the conduit.
2. The multi-tube vibration damper according to the preceding embodiment 1, wherein the damper inner tube wall opening is cylindrical, in particular has an edge that runs round cylindrically.
3. The multi-tube vibration damper according to one of embodiments 1 to 2, wherein a geometric transition structure is formed in the region between the damper inner tube wall and the conduit, said transition structure having a profile differing from an angular profile.
4. The multi-tube vibration damper according to embodiment 3, wherein the geometric transition structure is selected from a group of an indentation into the interior of the damper inner tube, a bulge into the compensation chamber, a spherical cap shape, a corrugated shape, or a combination thereof.
5. The multi-tube vibration damper according to one of embodiments 3 to 4, wherein the geometric transition structure has a stepped profile.
6. The multi-tube vibration damper according to one of the preceding embodiments 1 to 5, wherein the connecting piece opening into the damper inner tube wall opening is sealed against the damper inner tube outer face by means of a sealing ring in the mouth region, in particular in the cylindrical region of the damper tube inner wall opening.

The invention also comprises the combinations of the first embodiments with the second embodiments and/or the further embodiments. The combinations of the first embodiments with the second embodiments and/or the further embodiments are possible configurations of the invention.

### BRIEF DESCRIPTION OF THE DRAWINGS

The multi-tube vibration damper according to the invention having adjustable damping force for a vehicle is explained using the drawing.

FIG. 1 schematically shows a longitudinal section through a multi-tube vibration damper having adjustable damping force for a vehicle according to one embodiment of the invention,

FIGS. 2a, b, c schematically show a longitudinal section through the damper inner tube comprising the region of the damper tube inner wall opening including a cross section through the damper inner tube in the region of the damper tube inner wall opening according to embodiments of the invention.

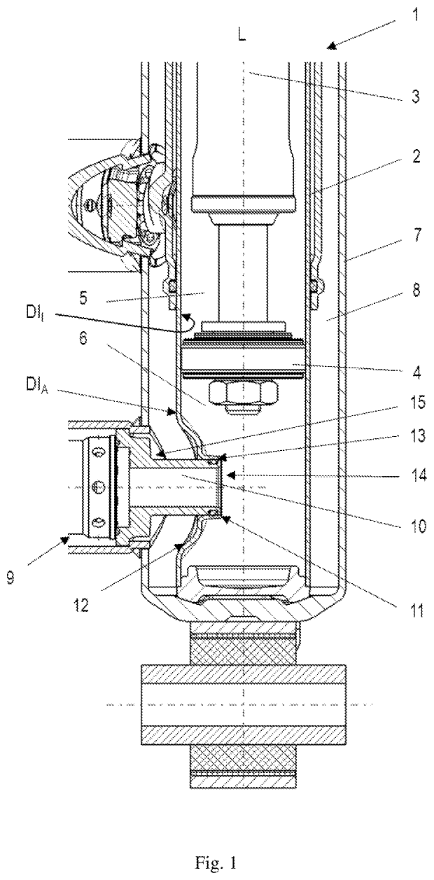

FIG. 1 shows a longitudinal section through a multi-tube vibration damper 1 having a damper inner tube 2 that is at least partially filled with damping medium and has a damper inner tube wall, wherein the damper inner tube wall has a damper inner tube inner face DI_{I} and a damper inner tube outer face DI_{A}. A piston rod 3 is arranged movably back and forth in the damper inner tube 2, wherein a working piston 4 is movable together with the piston rod 3, by means of which working piston the interior of the damper inner tube 2 is divided into a working chamber 5 on the piston rod side and a working chamber 6 remote from the piston rod. A damper outer tube 7 having a damper outer tube wall is arranged coaxially around the damper inner tube 2, and a compensation chamber 8 is formed between the damper outer tube 7 and the damper inner tube 2. A damping module 9 having a connecting piece 10 is arranged on the outside of the damper outer tube wall, and the connecting piece 10 runs fluid-tightly from the damping module 9 through a damper outer tube wall opening 15 for fluid connection between the working chamber 6 remote from the piston rod and the damping module 9 and opens fluid-tightly into a damper inner tube wall opening 14. A conduit 11 is formed integrally from the damper inner tube wall, wherein the conduit 11 protrudes into the interior of the damper inner tube 2 and opens into the interior of the damper inner tube 2 in the damper inner tube wall opening 14. The connecting piece 10 is arranged coaxially inside the conduit 11. A geometric transition structure 12 is formed as an indentation in the region between the damper inner tube wall and the conduit 11. The connecting piece 10 opening into the damper inner tube wall opening 14 is sealed against the damper inner tube outer face DI_{A} by means of a sealing ring 13 in the mouth region, that is, in the cylindrical region of the damper inner tube wall opening 14.

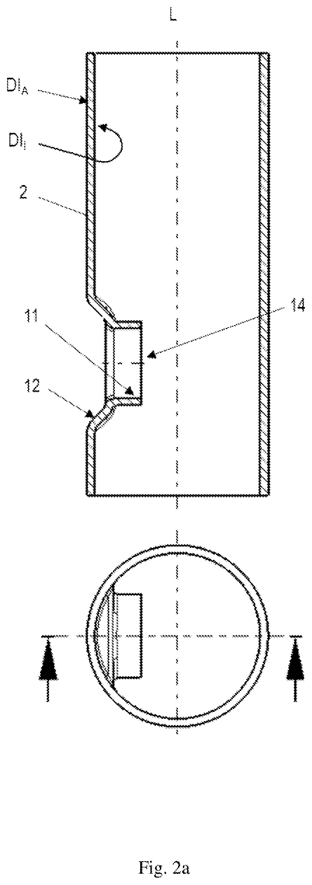

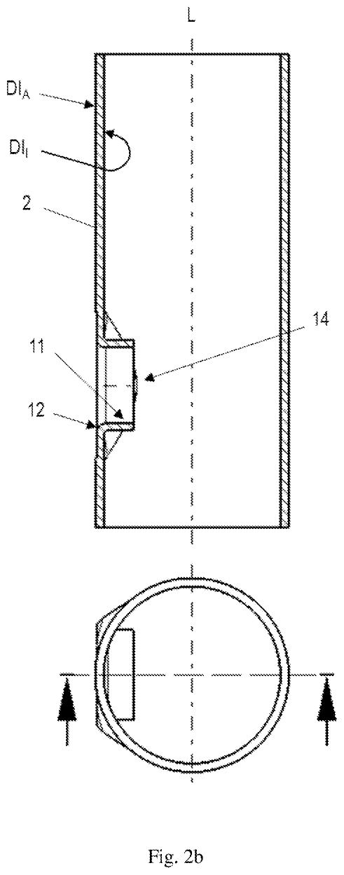

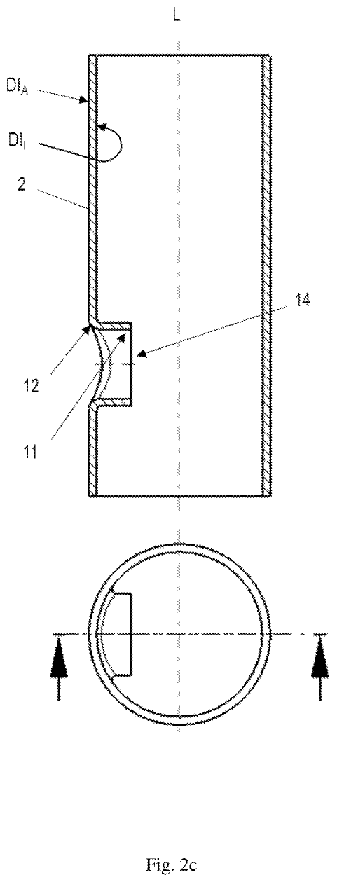

FIGS. 2a, b, c show longitudinal sections through the damper inner tube 2 having the damper inner tube wall comprising the damper inner tube inner face DI_{I} and the damper inner tube outer face DI_{A}, comprising the region of the damper inner tube wall opening 14 including a cross section through the damper inner tube 2 in the region of the damper inner tube wall opening 14, in each case with the conduit 11 and the geometric transition structure 12. The geometric transition structure 12 is shown with a different profile in each of the embodiments of FIGS. 2a, 2b and 2c.

### INDUSTRIAL APPLICABILITY

Multi-tube vibration dampers, in particular twin-tube vibration dampers, having adjustable damping force of the type described above are used in the production of multi-tube vibration dampers, in particular of chassis of vehicles, in particular motor vehicles, of motorcycles, of bicycles, of snowmobiles, of electric scooters.

### LIST OF REFERENCE SIGNS

1=Multi-tube vibration damper
2=Damper inner tube
3=Piston rod
4=Working piston
5=Working chamber on piston rod side
6=Working chamber remote from piston rod
7=Damper outer tube
8=Compensation chamber
9=Damping module
10=Connecting piece
11=Conduit
12=Indentation
13=Sealing ring
14=Damper inner tube wall opening
15=Damper outer tube wall opening
DI_{I}=Damper inner tube inner face
DI_{A}=Damper inner tube outer face
L=Longitudinal axis

1.-6. (canceled)

7. A multi-tube vibration damper for a vehicle having adjustable damping, comprising:
a damper inner tube at least filled partially with a damping medium, and including a damper inner tube wall, wherein the damper inner tube wall includes a damper inner tube inner face (DI_{I}) and a damper inner tube outer face (DI_{A});
a piston rod arranged movably within the damper inner tube;
a working piston arranged movable together with the piston rod, by means of which an interior of the damper inner tube is divided into a working chamber on the piston rod side and a working chamber remote from the piston rod;
a damper outer tube having a damper outer tube wall, wherein the damper outer tube is arranged coaxially around the damper inner tube, and a compensation chamber is defined between the damper outer tube and the damper inner tube;
a damping module having a connecting piece, wherein the damping module is arranged on the outside of the damper outer tube wall, and the connecting piece runs fluid-tightly from the damping module through a damper outer tube wall opening configured for creating a fluid connection between the working chamber remote from the piston rod and the damping module and configured to open fluid-tightly into a damper inner tube wall opening; and
a conduit formed integrally from the damper inner tube wall, wherein the conduit protrudes into the interior of the damper inner tube and opens into the interior of the damper inner tube in the damper inner tube wall opening, wherein the connecting piece is arranged coaxially inside the conduit.

8. The multi-tube vibration damper of claim 1, wherein the damper inner tube wall opening is cylindrical, including a cylindrical edge.

9. The multi-tube vibration damper of claim 1, wherein a geometric transition structure is formed in between the damper inner tube wall and the conduit, the transition structure having a profile differing from an angular profile.

10. The multi-tube vibration damper of claim 1, wherein the geometric transition structure is selected from a group of: an indentation into the interior of the damper inner tube, a bulge into the compensation chamber, a spherical cap shape, a corrugated shape, or a combination thereof.

11. The multi-tube vibration damper of claim 9, wherein the geometric transition structure includes as a stepped profile.

12. The multi-tube vibration damper of claim 1, wherein the, connecting piece opening into the damper inner tube wall opening is sealed against the damper inner tube outer face (DI_{A}) by means of a sealing ring in the mouth region.
